(19) United States
(12) Patent Application Publication
(10) Pub. No.: US 2025/0153267 A1
(43) Pub. Date: May 15, 2025

(54) SYSTEMS, DEVICES, AND METHODS FOR SURFACE PREPARATION FOR BOND ENHANCEMENT IN ADDITIVE DEPOSITION PROCESSES

(71) Applicant: Blue Origin, LLC, Kent, WA (US)

(72) Inventors: W. Douglas Hartley, Renton, WA (US); Max Jensen, Seattle, WA (US); Kris Heitmeyer, Sumner, WA (US); Kam To Law, Seattle, WA (US)

(21) Appl. No.: 18/945,197

(22) Filed: Nov. 12, 2024

Related U.S. Application Data
(60) Provisional application No. 63/598,465, filed on Nov. 13, 2023.

(51) Int. Cl. B23K 20/12; B23K 20/14; B33Y 10/00; B33Y 30/00

(52) U.S. Cl. CPC B23K 20/1245; B23K 20/1215; B23K 20/14; B33Y 10/00; B33Y 30/00

(57) ABSTRACT

An additive friction stir deposition device is provided. In one aspect, the device includes a shoulder configured to rotate about a central axis. The shoulder includes a channel extending from a first end of the shoulder to a second end of the shoulder. The channel allows a filler material to pass through the shoulder from the first end towards the second end. The shoulder configured to deposit the filler material as the device is advanced along a deposition surface. The device also includes a wire brush skirt configured to co-rotate with the shoulder and contact the deposition surface as the device is advanced along the deposition surface. The device also includes a gas shroud configured to direct pressurized gas toward the deposition surface and remove contaminants as the device is advanced along the deposition surface.

### CROSS-REFERENCE TO RELATED APPLICATIONS

This application claims the benefit of U.S. Provisional Application No. 63/598,465, filed Nov. 13, 2023, which is hereby incorporated by reference in its entirety.

### BACKGROUND

### Field

The technology relates generally to additive friction stir deposition (AFSD) systems, devices, and methods, such as systems, devices, and methods that can prepare a surface for bond enhancement in additive deposition processes.

### Description of the Related Art

Surface preparation prior to use of an AFSD device typically occurs minutes or even hours prior to deposition of material on the surface. Surface preparation that occurs minutes or hours prior to deposition increases the chance of oxidation and contamination.

### SUMMARY

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing systems and methods related to AFSD.

In one aspect, an additive friction stir deposition device includes a shoulder, a collar, a wire brush skirt, and a gas shroud. The shoulder is configured to rotate about a central axis. The shoulder includes a channel extending from a first end of the shoulder to a second end of the shoulder. The channel is configured to allow a filler material to pass through the shoulder from the first end towards the second end. The shoulder is further configured to deposit the filler material as the device is advanced along a deposition surface. The collar is coupled to the shoulder. The collar includes a plurality of openings through a first side of the collar. The wire brush skirt is coupled to a second side of the collar opposite the first side of the collar. The gas shroud includes an inlet configured to direct pressurized gas through the plurality of openings in the collar. The pressurized gas is configured to remove contaminants as the device is advanced along the deposition surface.

In some embodiments, the device includes an adapter configured to couple the collar to the shoulder. In some embodiments, the first side of the collar includes an aperture configured to receive a portion of the shoulder. In some embodiments, the plurality of openings are arranged around the aperture. In some embodiments, the wire brush skirt is configured to scratch the deposition surface as the device is advanced along the deposition surface. In some embodiments, the wire brush skirt is impermeable or semi-permeable to a gas flowing from the gas shroud. In some embodiments, the wire brush skirt is configured to scratch the deposition surface as the gas shroud removes contaminants and the shoulder deposits filler material. In some embodiments, the shoulder includes an outer diameter that decreases from an upper portion at or near the first end to a lower portion at or near the second end. The upper portion of the shoulder has a first diameter. A middle portion of the shoulder has a second diameter. The lower portion of the shoulder has a third diameter. In some embodiments, the collar is coupled to the lower portion of the shoulder and the gas shroud is positioned around the middle portion of the shoulder. In some embodiments, the device includes a first seal positioned between a first surface of the gas shroud and the first side of the collar and a second seal positioned around the middle portion of the shoulder between a second surface of the gas shroud and a ledge of the upper portion of the shoulder. In some embodiments, the plurality of openings include an airfoil geometry.

In another aspect, an additive friction stir deposition device includes a shoulder, a wire brush skirt, and a gas shroud. The shoulder is configured to rotate about a central axis. The shoulder includes a channel extending from a first end of the shoulder to a second end of the shoulder. The channel is configured to allow a filler material to pass through the shoulder from the first end towards the second end. The shoulder is further configured to deposit the filler material as the device is advanced along a deposition surface. The wire brush skirt is configured to co-rotate with the shoulder and contact the deposition surface as the device is advanced along the deposition surface. The gas shroud is configured to direct pressurized gas toward the deposition surface and remove contaminants as the device is advanced along the deposition surface.

In some embodiments, the device includes an adapter configured to couple the wire brush skirt to the shoulder. In some embodiments, the device includes a collar configured to couple the wire brush skirt to the shoulder. In some embodiments, the device includes a pin configured to extend through an opening in a wall of the collar and into a recess of the adapter. In some embodiments, the adapter is coupled to the shoulder by an interference fit. In some embodiments, the shoulder includes an outer diameter that decreases from an upper portion at or near the first end to a lower portion at or near the second end. The upper portion of the shoulder has a first diameter. A middle portion of the shoulder has a second diameter. The lower portion of the shoulder has a third diameter. In some embodiments, the wire brush skirt is coupled to the lower portion of the shoulder and the gas shroud is positioned around the middle portion of the shoulder.

In another aspect, a method of additive friction stir deposition includes advancing an additive friction stir deposition device along a deposition surface. The method also includes contacting the deposition surface with a wire brush skirt configured to co-rotate with a rotating shoulder of the device. The method also includes removing contaminants from the deposition surface by directing a pressurized gas toward the deposition surface. The method also includes depositing a filler material from a channel extending through the rotating shoulder to the deposition surface

In some embodiments, the method includes directing the pressurized gas through a plurality of openings in a first side of a collar configured to couple the wire brush skirt to the rotating shoulder. In some embodiments, the method includes scratching the deposition surface occurs prior to or at the same time as depositing the filler material. In some embodiments, the method includes removing contaminants from the deposition surface occurs prior to or at the same time as depositing the filler material.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. Understanding that these drawings depict only several embodiments in accordance with the disclosure and are not to be considered limiting of its scope, the disclosure will be described with additional specificity and detail through use of the accompanying drawings. In the drawings, similar symbols typically identify similar components, unless context dictates otherwise. The illustrative embodiments of the present disclosure are not meant to be limiting. Other embodiments may be utilized, and other changes may be made, without departing from the spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of the present disclosure.

FIG. 1 is a partial cross-sectional view of a schematic illustration of an AFSD device according to an embodiment of the present disclosure.

FIG. 2 is a perspective view of an AFSD device according to another embodiment of the present disclosure.

FIG. 3 is a cross-sectional view of the AFSD device of FIG. 1 according to an embodiment of the present disclosure.

FIG. 4 is an exploded view of the AFSD device of FIG. 1 according to an embodiment of the present disclosure.

FIG. 5 is a bottom cross-sectional perspective view of the AFSD device of FIG. 1 according to an embodiment of the present disclosure.

FIG. 6 is a bottom view of the AFSD device of FIG. 1 according to an embodiment of the present disclosure.

### DETAILED DESCRIPTION

Embodiments of the present disclosure generally relate to improved tools, devices, systems, and methods related to AFSD processes. AFSD processes can be a type of friction stir additive manufacturing (FSAM). AFSD is a large-scale additive manufacturing technology which is relatively new and increasingly gaining industrial relevance. Embodiments according to the present disclosure can lead to better bonding and material properties during AFSD processes. To-date, surface preparation would occur minutes or even hours before deposition. However, such time delta leaves opportunities for oxidation and contamination. Therefore, there is a need for an improvement addressing oxidation and/or contamination challenges in this area. The embodiments according to the present disclosure can be advantageous in allowing for surface preparation to occur concurrently or almost concurrently with the deposition process.

It should be appreciated that the interface bond formation between layers and/or substrates is an important step during the additive manufacturing process. AFSD is a solid-state additive manufacturing (AM) process, and without the enhanced mobility intruded by the melt phase, bond line contaminants can be detrimental.

The presently disclosed improvements relate to the AFSD tools, apparatuses, articles of manufacturing, systems, and methods. In one embodiment, the improvements allow for a continuous in-situ surface preparation to enhance the solid-state bond forming during an additive manufacturing process. The AFSD devices according to the present disclosure can improve and increase the functionality of existing tools and can improve the print quality and properties of deposited material. The AFSD devices according to the present disclosure can be used in the manufacturing of large metallic structures, welding processes to join parts, and 3D printing processes.

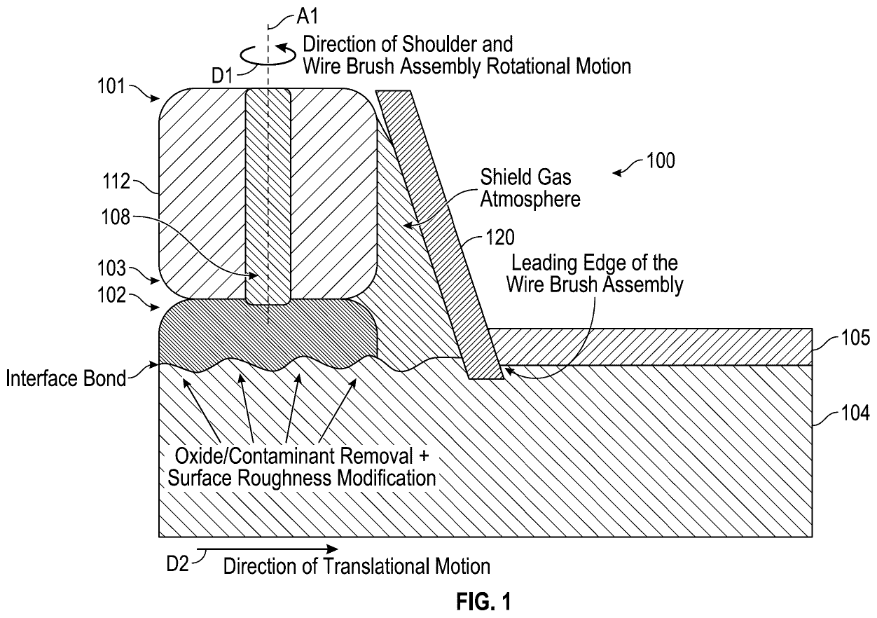

Various example embodiments of devices, systems, and methods according to the present disclosure will now be described with reference to the figures. As illustrated in FIGS. 1-6, the present disclosure provides surface preparation by scratch brushing a surface of a substrate and applying pressurized gas aimed at the print head. The pressurized gas can be a shield gas. To address contaminant and/or oxidation challenges, mechanical action of a wire brush assembly, as shown in the figures, operates around a deposition zone of an AFSD device, dynamically affecting the surface immediately prior to, or substantially at the same time as, bonding. Furthermore, the pressurized gas can carry small debris or other contaminants away from the deposition zone, substantially continuously “preparing” the surface for immediate or near immediate deposition. This improvement can result in a superior mechanical performance of AFSD material, including in the build direction, directly off of the print bed.

As shown in FIG. 1, the present disclosure offers combined surface preparation and the deposition, in-situ, occurring substantially at the same time. The surface preparation by wire brushing can proceed continuously and immediately prior to the deposition, alleviating substantial time delays between the two steps. Furthermore, the pressurized gas can act to modify surface oxidation reactions and remove potential contaminants from the bonding surface immediately prior to bonding. In other words, this process can combine surface preparation and atmosphere control at the point of deposition leading to better performance and properties.

FIGS. 1-6 illustrate an AFSD device 100 according to an embodiment of the present disclosure. The AFSD device 100 can include a shoulder 112, a wire brush assembly 116, and a gas shroud 130. The AFSD device 100 can be used to deposit a filler or feed material to a deposition zone 102. The deposition zone 102 can include the area where the filler material exits the AFSD device 100 and/or the area where the filler material contacts a substrate 104. The deposition zone 102 can move as the AFSD device 100 is moved across the substrate 104. In other terms, the deposition zone 102 can be the area between the AFSD device 100 and the substrate 104 and include the area where the filler material is deposited.

The filler material can flow through a channel 108 of the shoulder 112. The shoulder 112 can be a tool head of an AFSD device 100. The channel 108 can extend from a first end 101 of the shoulder 112 to a second end 103 of the shoulder 112. The wire brush assembly 116 can be located at or near the second end 103 of the shoulder 112. The shoulder 112 can be configured to rotate about a central axis A1 extending through the center of the shoulder 112. The direction of rotation D1 of the shoulder 112 about the central axis A1 can be clockwise or counter-clockwise. The rotation of the shoulder 112 can generate heat to soften the filler material, which can allow the filler material to flow through the channel 108 and to the deposition zone 102. The filler material can flow from the first end 101 of the shoulder 112 to the second end 103 of the shoulder 112. The channel 108 can be configured to allow the filler material to pass through the shoulder 112 from the first end 101 to the second end 103.

The shoulder 112 can be configured to move across or above the surface of the substrate 104. In one example, the shoulder 112 moves in a transverse direction relative to the substrate 104. For example, with reference to FIG. 1, the direction D2 of movement of the shoulder 112 relative to the page can be left to right. Alternatively, the substrate 104 can be moved and the shoulder 112 can remain stationary. While being moved across or advanced along the surface of the substrate 104, the filler material can continue to be deposited to the deposition zone 102.

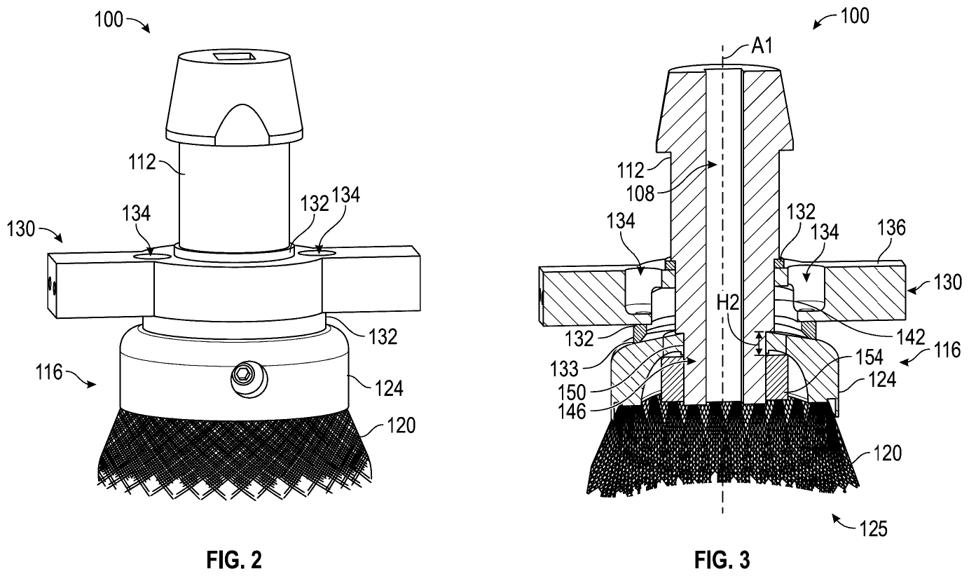

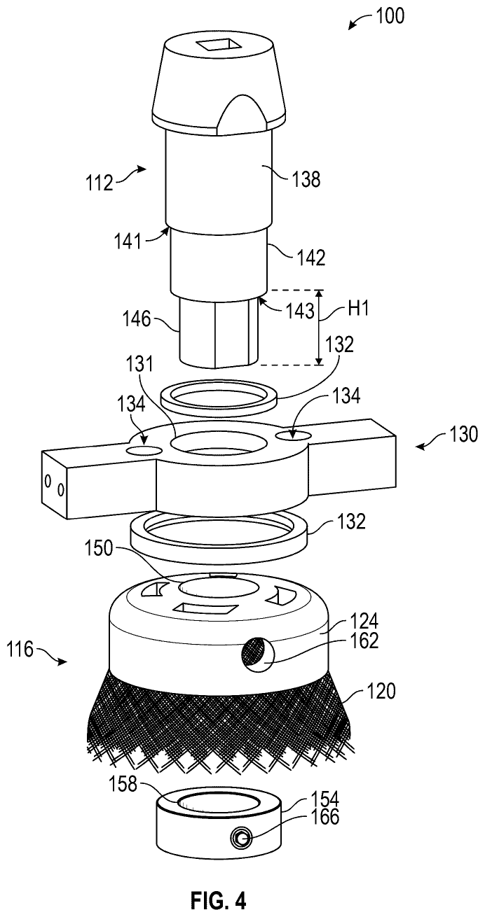

As shown in FIG. 4, the shoulder 112 can have a stepped diameter. The stepped diameter can decrease as it approaches the wire brush assembly 116. A first portion 138 of the shoulder 112 may have a first diameter or width. The first portion 138 may also be referred to as an upper portion. A second portion 142 may have a second diameter or width. The second portion 142 may also be referred to as a middle portion. A third portion 146 may have a third diameter or width. The third portion 146 may also be referred to as a lower portion. In some embodiments, the first diameter may be greater than both the second diameter and the third diameter. The second diameter may be greater than the third diameter. A first ledge or step 141 may be defined by the change in diameter between the first portion 138 and the second portion 142. A second ledge or step 143 may be defined by the change in diameter between the second portion 142 and the third portion 146. While the shoulder 112 of the non-limiting embodiment of FIGS. 2-6 includes three portions, any number of portions may be used. In addition, while the shoulder 112 includes portions having different diameters, portions of the shoulder 112 may have the same or similar diameters. For example, in some embodiments such as that illustrated in FIG. 1, the shoulder 112 may have a constant diameter along a height of the shoulder 112 and not have a stepped diameter.

The AFSD device 100 can include a wire brush assembly 116. The wire brush assembly 116 can include a wire brush skirt 120 and a collar 124. The wire brush assembly 116 can be a mechanically-bonded circumferential wire brush skirt. The wire brush assembly 116 can co-rotate with the shoulder 112. For example, the wire brush assembly 116 and the shoulder 112 can rotate about the central axis A1 in the direction D1, or in a rotational direction opposite to direction D1. The rotation of the wire brush assembly 116 can be referred to as continuous rotary in-situ surface preparation (“C.R.I.S.P.”). The wire brush assembly 116 can be mechanically coupled to the shoulder 112 or another component of the AFSD device 100. For example, the wire brush assembly 116 can be removably attached or bonded to the shoulder 112 using, for example, mechanical fasteners, welding, screw threads, or a friction tightening collar). Other means of attachment are possible as would be apparent to one skilled in the art. The wire brush skirt 120 can include a plurality of wires coupled to an end of the collar 124. The plurality of wires can be coupled to a substantially planar surface at an end of the collar 124. The plurality of wires can include wire brush bristles. The plurality of wires can be arranged in a crisscross pattern. The plurality of wires can be arranged in an overlapping pattern. The plurality of wires can be arranged in a circular pattern. In some embodiments, a density of the plurality of wires can be greater near an inner diameter of the wire brush skirt 120 than a density of the plurality of wires near an outer diameter of the wire brush skirt 120. The wires can be arranged to define an outlet 125 that is communication with the second end 103 of the shoulder 112. Non-limiting examples of the wire brush skirt 120 include iron-alloys, steels, nickel-alloys, molybdenum alloys, tungsten alloys, and other refractory metal alloys. In some embodiments, the material of the wire brush skirt 120 may have a coating to increase abrasion and/or decrease wear and adhesion of the filler material (for example, a carbide or nitride coating).

In some embodiments, the wire brush assembly 116 can be coupled to and/or positioned around the third portion 146 of the shoulder 112. The collar 124 can have an aperture 150 configured to receive the third portion 146 of the shoulder 112. The collar 124 can be coupled to the shoulder 112. In some embodiments, an adapter 154 can be used to couple the wire brush assembly 116 to the shoulder 112. The adapter 154 can couple the collar 124 to the shoulder 112. The adapter 154 can be ring shaped. The adapter 154 can have an aperture 158 configured to receive the third portion of the shoulder 112. When assembling the AFSD device 100, the third portion 146 of the shoulder 112 can be inserted into the aperture 150 of the collar 124. The collar 124 can be positioned such that a surface of the collar 124 contacts or is adjacent to the ledge 143 defined by the change in diameter between the second portion 142 and the third portion 146 of the shoulder 112. The ledge 143 can prevent the collar from moving toward and around the second portion 142 of the shoulder 112. The third portion 146 of the shoulder 112 may have a height H1 that exceeds a height H2 of the aperture 150 of the collar 124. The adapter 154 may be received in a cavity of the collar 124. The adapter 154 may be positioned around the third portion 146 of the shoulder 112 that protrudes out of the aperture 150 of the collar 124. A pin or screw may be used to secure the adapter 154 to the collar 124. For example, the pin can be inserted into and through an opening 162 of the collar and into an opening or recess 166 of the adapter. In some instances, the pin can extend through the opening 166 of the adapter and come into contact with or extend into a recess of the third portion 146 of the shoulder 112. In other embodiments, the adapter 154 can be secured to the third portion 146 of the shoulder by way of friction or interference fit.

In one example, during use, a portion of the wire brush skirt 120 can protrude beyond the second end 103 of the shoulder 112. A portion of the wire brush skirt 120 can be flush with the second end 103 of the shoulder 112. The wire brush skirt 120 can interact with or contact a target substrate material (which can include previously deposited filler or feed material) to enhance bonding. In embodiments of the present disclosure, the interaction or contact with the wire brush skirt 120 can remove oxides or other contaminants and/or physically modify a finish or surface of the substrate material, for example roughen a surface of the substrate material. As shown in FIG. 1, the wire brush skirt 120 can penetrate a surface oxide and contaminant layer 105 that is on or over the substrate 104. In some instances, the wire brush skirt 120 can penetrate a portion of the substrate 104. The wire brush skirt 120 can be configured to alter the state of the surface of the substrate 104 as the AFSD device 100 is advanced along the substrate 104. For example, the wire brush skirt 120 can be configured to scratch, roughen, abrade, scrape, rub, or coarsen the surface of the substrate as the wire brush skirt 120 co-rotates and advances translationally with the shoulder 112. As another example, the wire brush skirt 120 can be configured to scratch, roughen, abrade, scrape, rub, or coarsen a surface oxide and contaminant layer 105 that is on or over the substrate 104 as the wire brush skirt 120 co-rotates and advances translationally with the shoulder 112. The alteration of the surface of the substrate and/or the surface oxide and contaminant layer 105 may disturb surface oxides present on the surface, cold work a thin surface layer of material (for example, provide surface abrasion by a hard material to introduce beneficial properties to the surface of metals), or remove a thin surface layer of a metallic material, and/or modify the surface roughness of the material. The alteration of the surface can enhance the solid state bond achieved during deposition, and/or lower the required surface strain, temperature, and/or mechanical forces required to achieve a robust interface bond. For example, the alteration of the surface can increase the strength and/or toughness of the bond between the added material and the substrate 104. The alteration of the surface can also increase the real bonded area (for example, the full width of a deposition track can have a conformal metallic interface bond across an entire width of the track, as opposed to a superficial and heavily oxidized interface especially near the edges of the deposition track). In contrast, typical methods can result in the outer edges of the deposition track being heavily oxidized and having poor strength.

The AFSD device 100 can include a gas shroud 130, as illustrated in FIGS. 2-6. Although embodiments of the AFSD device 100 that include a gas shroud are described with reference to FIGS. 2-6, it will be understood that embodiments of AFSD devices according to the present disclosure need not include a gas shroud 130. The gas shroud 130 can be in a fixed position relative to the shoulder 112 and the wire brush assembly 116. For example, the gas shroud 130 may not rotate about the central axis A1 while the wire brush assembly 116 may co-rotate with the shoulder 112 about the central axis A1. The gas shroud 130 can be positioned adjacent to the wire brush assembly 116. The gas shroud 130 can be positioned between the wire brush assembly 116 and the first end 101 of the shoulder 112. The gas shroud can be positioned around the shoulder 112. For example, the gas shroud 130 can be positioned around the second portion 142 of the shoulder 112. The gas shroud 130 can have an aperture 131 configured to receive the second portion 142 of the shoulder 112.

In some embodiments, the gas shroud 130 may include one or more seals 132. The one or more seals 132 may have a ring shape. The one or more seals 132 can include o-rings formed of an elastomeric or flexible material. A first seal 132 may be positioned between a first exterior surface of the gas shroud 130 and the first portion 138 of the shoulder 112. For example, the first seal 132 may be positioned adjacent to the ledge 141 defined by the change in diameter between the first portion 138 and the second portion 142 of the shoulder 112. The first seal 132 may be sized to directly contact an outer surface of the second portion 142 of the shoulder 112. The first seal 132 may be sized to create a direct contact seal around an outer surface of the second portion 142 of the shoulder 112. A second seal 132 may be positioned between an exterior surface of the collar 124 of the wire brush assembly 116 and a second exterior surface of the gas shroud 130 opposite the second exterior surface. The second seal 132 may be positioned around the second portion 142 of the shoulder 112. The second seal 132 may be sized such that it does not directly contact the second portion 142 of the shoulder 112. The second seal 132 may be sized to create an indirect seal around an outer surface of the second portion 142 of the shoulder 112. The second seal 132 may be positioned such that openings 121 in the collar 124, described in more detail below, are positioned within an inner perimeter of the second seal 132. For example, the second seal 132 may be positioned outward or further away from the central axis A1 as compared to the openings 121. A portion of the second seal 132 may rest in a recess 133 on an exterior surface of the collar 124, as shown in FIG. 3, to retain the seal 132 in the intended position.

When assembling the AFSD device 100, the first seal 132 can be advanced over the third portion 146 and the second portion 142 of the shoulder 112. The first seal 132 may be positioned such that it rests against the ledge 141 formed by the change in diameter between the first portion 138 and the second portion 142 of the shoulder 112. The third portion 146 and the second portion 142 of the shoulder 112 may then be inserted into and through the aperture 131 of the gas shroud 130. The gas shroud 130 can be positioned such that it is around the second portion 142 of the shoulder 112 and adjacent to the first seal 132. The second seal 132 can then be advanced over the third portion 146 and the second portion 142 of the shoulder 112 and positioned adjacent to the gas shroud 130. The wire brush assembly 116 can then be coupled to the shoulder 112 according to the present disclosure.

The gas shroud 130 can include one or more fluid inlets 134. The fluid inlets 134 can be configured to supply gas flow to the wire brush assembly 120. The gas flow can be an ambient gas flow or a pressurized gas flow. In examples supplying pressurized gas flow, the pressurized gas may be a welding “shield gas.” The type and amount of gas supplied can be optimally varied depending on the desired extent to modify the immediate gaseous environment around the shoulder 112 and/or to modify the oxidation behavior. A welding “shield gas” may be a gas that is used during welding processes to protect the weld area from oxygen and/or water vapor. Example welding shield gases include carbon dioxide, argon, and helium. The one or more fluid inlets 134 can be provided in a surface 136 of the gas shroud 130. The one or more fluid inlets 134 may include a first opening in the surface 136 and a second opening in fluid communication with a space defined by an interior circumferential surface of the gas shroud 130, an outer surface of the shoulder 112, the second seal 132, and an exterior surface of the collar 124. The first opening and the second opening may be connected by a channel. The pressurized gas may be directed through the first opening of the inlet 134, through the channel of the inlet 134, out the second opening of the inlet 134, and out the outlet 125 of the wire brush assembly 116. The wire brush skirt 120 may be completely permeable to the pressurized gas. The wire brush skirt 120 may be modified to be permeable or semi-permeable to brushed particles to escape or be driven out by the pressurized gas. The spacing between wires of the wire brush skirt 120 can be sized to control the permeability. For example, if the spacing or density of the wires of the wire brush skirt 120 is comparable to the size of the particles, then the particles may not be able to easily escape. A low density of the wire brush skirt 120 relative to the particle size can facilitate escape and/or ejection of the particles through the wires of the wire brush skirt 120. In some embodiments of the present disclosure, brushed particulate ejecta permeates the wire brush skirt 120, driven by the pressurized gas. Furthermore, the wire brush skirt 120 and gas shroud 130 interface may include designed gaps.

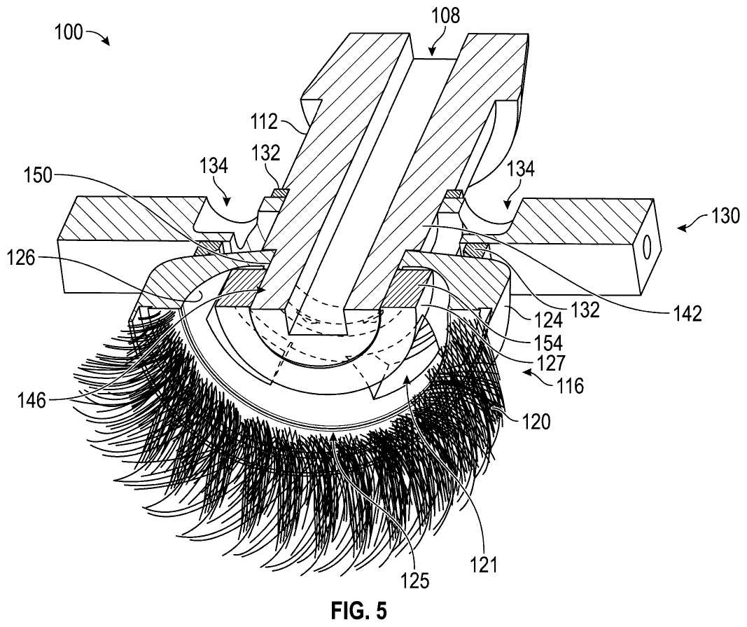

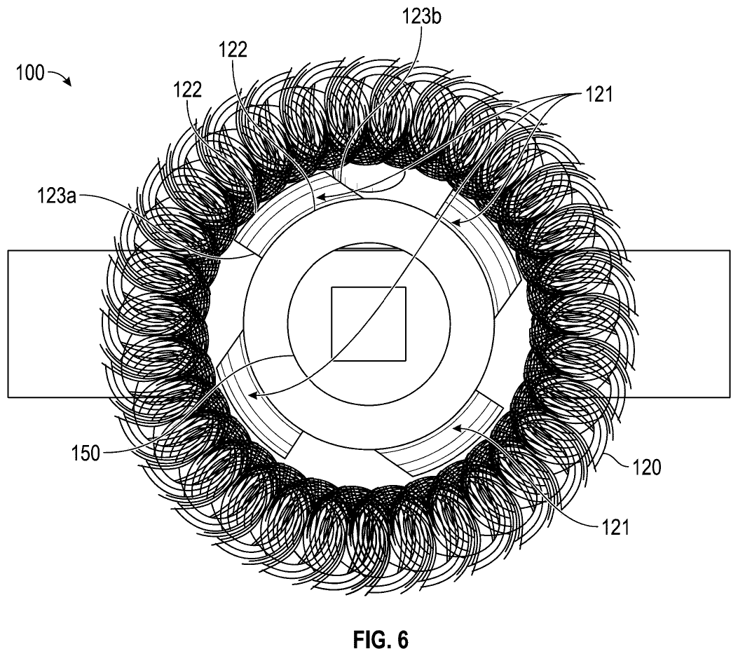

Embodiments of the collar 124 can include a plurality of openings 121. In some embodiments, the plurality of openings 121 can include a bladed disk or turbine blade airfoil-type surface. One non-limiting example is illustrated in FIGS. 5 and 6. The openings 121 can be apertures extending between an exterior surface of the collar 124 and an interior surface of the collar 124. The openings 121 can pass through a first side of the collar 124 between an exterior surface and an interior surface of the collar 124. While four openings 121 are shown, any number of openings 121 can be suitably implemented. For example, there can be 1, 2, 3, 4, or more openings 121. The openings 121 be arranged about the aperture 150. The openings 121 can be arranged circumferentially about the aperture 150. The openings 121 can have an airfoil geometry. Each opening 121 may have two curved edges 122 connected by two linear edges 123a, 123b. The two linear edges may be angled such that they define a leading edge 123a of the opening 124 and a trailing edge 123b of the opening 124. The openings 121 can be configured to pull the gas aggressively downward around and into the immediate deposition zone of the AFSD device 100 via a pressure gradient between the fluid inlets 134 of the gas shroud 130 and the outlet 125 of the wire brush skirt 120. For example, after flowing through the one or more inlets 134 of the gas shroud 130, the pressurized gas can be directed through the openings 121 of the collar 124 and through the outlet 125 of the wire brush skirt 120. In some embodiments, the pressurized gas may be directed through the openings 121 to a space defined by an inner surface 126 of the collar 124 and an outer surface 127 of the adapter 154. The pressurized gas may then be directed through the outlet 125 of the wire brush skirt 120.

In some embodiments, the pressurized gas may act to physically carry away small chunks, chips, or other contaminant material away from the shoulder 112 of the AFSD device 100, which otherwise may be included in the AFSD bond line being formed. Preventing contaminant inclusions and/or modifying the surface oxides of the substrate may further influence the properties of the interface bond during the AFSD process.

While the above detailed description has shown, described, and pointed out novel features of the present disclosure as applied to various embodiments, it will be understood that various omissions, substitutions, and changes in the form and details of the device or process illustrated may be made by those skilled in the art without departing from the spirit of the present disclosure. As will be recognized, the present disclosure may be embodied within a form that does not provide all of the features and benefits set forth herein, as some features may be used or practiced separately from others. All changes which come within the meaning and range of equivalency of the claims are to be embraced within their scope. Throughout this disclosure, the term “fluid” encompasses both liquids and gases (for example, a shield gas).

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities, dimensions, and so forth used in the specification and claims are to be understood as being modified in all instances by the term “about.” Accordingly, unless indicated to the contrary, the numerical parameters set forth in the specification are approximations that may vary depending upon the desired properties sought to be obtained by embodiments of the present disclosure. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various embodiments, of ±1%, ±5%, ±10%, or ±20%.

The above description discloses several devices, methods, and materials of the present disclosure. The present disclosure is susceptible to modifications in the devices, methods, and materials, as well as alterations in the fabrication methods and equipment. Such modifications will become apparent to those skilled in the art from a consideration of this disclosure. Consequently, it is not intended that the present disclosure be limited to the specific embodiments disclosed herein, but that it covers all modifications and alternatives coming within the true scope and spirit of the present disclosure.

What is claimed is:

1. An additive friction stir deposition device comprising:
a shoulder configured to rotate about a central axis, the shoulder comprising a channel extending from a first end of the shoulder to a second end of the shoulder, the channel configured to allow a filler material to pass through the shoulder from the first end towards the second end, the shoulder further configured to deposit the filler material as the device is advanced along a deposition surface;
a collar coupled to the shoulder, the collar comprising a plurality of openings through a first side of the collar;
a wire brush skirt coupled to a second side of the collar opposite the first side of the collar; and
a gas shroud comprising an inlet configured to direct pressurized gas through the plurality of openings in the collar, the pressurized gas configured to remove contaminants as the device is advanced along the deposition surface.

2. The additive friction stir deposition device of claim 1, further comprising an adapter configured to couple the collar to the shoulder.

3. The additive friction stir deposition device of claim 1, wherein the first side of the collar comprises an aperture configured to receive a portion of the shoulder.

4. The additive friction stir deposition device of claim 3, wherein the plurality of openings are arranged around the aperture.

5. The additive friction stir deposition device of claim 1, wherein the wire brush skirt is configured to scratch the deposition surface as the device is advanced along the deposition surface.

6. The additive friction stir deposition device of claim 1, wherein the wire brush skirt is impermeable or semi-permeable to a gas flowing from the gas shroud.

7. The additive friction stir deposition device of claim 1, wherein the wire brush skirt is configured to scratch the deposition surface as the gas shroud removes contaminants and the shoulder deposits filler material.

8. The additive friction stir deposition device of claim 1, wherein the shoulder comprises an outer diameter that decreases from an upper portion at or near the first end to a lower portion at or near the second end, the upper portion of the shoulder having a first diameter, a middle portion of the shoulder having a second diameter, and the lower portion of the shoulder having a third diameter.

9. The additive friction stir deposition device of claim 8, wherein the collar is coupled to the lower portion of the shoulder and the gas shroud is positioned around the middle portion of the shoulder.

10. The additive friction stir deposition device of claim 9, further comprising a first seal positioned between a first surface of the gas shroud and the first side of the collar and a second seal positioned around the middle portion of the shoulder between a second surface of the gas shroud and a ledge of the upper portion of the shoulder.

11. The additive friction stir deposition device of claim 1, wherein the plurality of openings comprise an airfoil geometry.

12. An additive friction stir deposition device comprising:
a shoulder configured to rotate about a central axis, the shoulder comprising a channel extending from a first end of the shoulder to a second end of the shoulder, the channel configured to allow a filler material to pass through the shoulder from the first end towards the second end, the shoulder further configured to deposit the filler material as the device is advanced along a deposition surface;
a wire brush skirt configured to co-rotate with the shoulder and contact the deposition surface as the device is advanced along the deposition surface; and
a gas shroud configured to direct pressurized gas toward the deposition surface and remove contaminants as the device is advanced along the deposition surface.

13. The additive friction stir deposition device of claim 12, further comprising an adapter configured to couple the wire brush skirt to the shoulder.

14. The additive friction stir deposition device of claim 13, further comprising a collar configured to couple the wire brush skirt to the shoulder.

15. The additive friction stir deposition device of claim 14, further comprising a pin configured to extend through an opening in a wall of the collar and into a recess of the adapter.

16. The additive friction stir deposition device of claim 13, wherein the adapter is coupled to the shoulder by an interference fit.

17. The additive friction stir deposition device of claim 12, wherein the shoulder comprises an outer diameter that decreases from an upper portion at or near the first end to a lower portion at or near the second end, the upper portion of the shoulder having a first diameter, a middle portion of the shoulder having a second diameter, and the lower portion of the shoulder having a third diameter.

18. The additive friction stir deposition device of claim 17, wherein the wire brush skirt is coupled to the lower portion of the shoulder and the gas shroud is positioned around the middle portion of the shoulder.

19. A method of additive friction stir deposition comprising:
advancing an additive friction stir deposition device along a deposition surface;
contacting the deposition surface with a wire brush skirt configured to co-rotate with a rotating shoulder of the device;
removing contaminants from the deposition surface by directing a pressurized gas toward the deposition surface; and
depositing a filler material from a channel extending through the rotating shoulder to the deposition surface.

20. The method of claim 19, further comprising directing the pressurized gas through a plurality of openings in a first side of a collar configured to couple the wire brush skirt to the rotating shoulder.

21. The method of claim 19, wherein scratching the deposition surface occurs prior to or at the same time as depositing the filler material.

22. The method of claim 19, wherein removing contaminants from the deposition surface occurs prior to or at the same time as depositing the filler material.
